(19) United States
(12) Patent Application Publication
(10) Pub. No.: US 2004/0244552 A1
(43) Pub. Date: Dec. 9, 2004

(54) Device for cutting food products

(76) Inventor: Gunther Weber, Zachow (DE)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/493,941

(22) PCT Filed: Sep. 10, 2002
(86) PCT No.: PCT/EP02/10151

(30) Foreign Application Priority Data
Oct. 31, 2001 (DE) 101 53 755.7

(51) Int. Cl. B26D 7/00; B26D 1/14

(52) U.S. Cl. 83/469; 83/167

(57) ABSTRACT

The invention relates to a device for cutting food products, wherein separating sheets can be inserted simultaneously between the cut products. The transport system for delivering the paper web from which the separating sheets are formed comprises a station for transversal perforation of the paper web. The paper web is delivered to the cutting plane in such a way that the transversal perforation is located on the cutting plane during each paper separating operation.

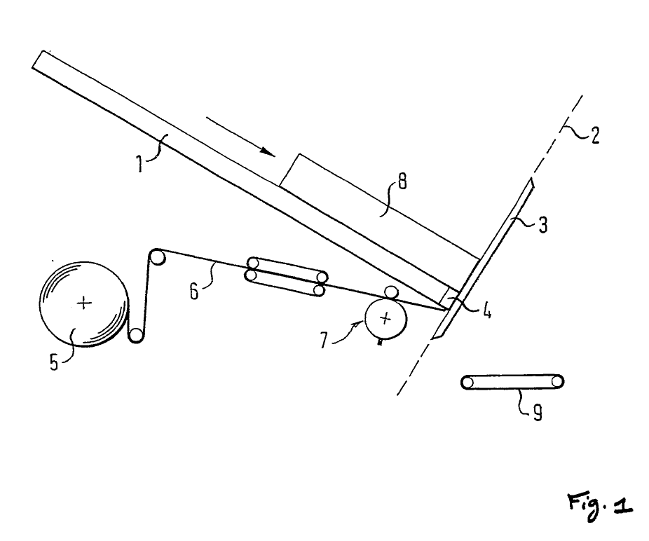

The invention relates to an apparatus for the slicing of food products such as sausage, ham, cheese and the like comprising a device for the supply of the products to be sliced to a cutting plane defined by a rotating cutting blade and by a cutting edge cooperating therewith and provided at the end of the product supply path as well as a transport system for a paper web which is drawn off from a dispensing roll, is supplied to the cutting plane and is fed in pre-determinable dependence on the cutting sequence such that the cutting blade, when cutting off a product slice, can also cut off a section from the paper web which falls together with the cut-off slice as an intermediate layer onto a collection surface for the sliced products.

Such an apparatus is known from EP 0 251 337 B1. It is possible by means of this known apparatus to introduce separating sheets between sequentially cut-off slices during the cutting step. The disadvantage of this known apparatus consists above all of the fact that a very sharp blade is necessary for the perfect carrying out of the paper cutting steps and the required blade sharpness can in each case only be maintained over a relatively limited operating period. The blade service life is accordingly reduced in line with this, that is the number of required blade changes or sharpening processes increases considerably in comparison with a cutting apparatus in which work is carried out without any intermediate paper layers. The consequence of this is that the total performance of the apparatus in question or of the slicer in question is interferingly impaired.

It is the object of the invention to eliminate the aforesaid disadvantages and accordingly to substantially increase the blade service life despite the required cutting of the paper web.

This object is satisfied starting from the initially named apparatus in that the transport system for the paper web includes a station for the transverse perforation of the paper web and in that the paper feed is controlled or regulated such that the transverse perforation lies in the cutting plane in each paper cutting step.

It becomes possible by the invention to clearly reduce the actual paper length to be cut because only the webs present between the openings of the perforation still have to be cut through. This has the consequence of a corresponding extension of the blade service life.

The transverse perforation can be designed such that the actual paper cutting length only amounts to 30 to 40% of the total width of the paper web and the total stability of the paper web is nevertheless so high that the required feed can take place without problem.

In accordance with an embodiment of the invention, an already perperforated paper web with corresponding transverse perforations at defined spacings can also be used, with the paper feed then having to be controlled or regulated using corresponding sensors such that, in turn, the transverse perforation lies exactly in the cutting plane in each paper cutting step and thus only the webs between the perforation openings have to be cut by the blade.

Further advantageous features of the invention are recited in the dependent claims.

An embodiment of the invention will be described with reference to the drawing which shows a slicer with a paper web supply in very schematic form.

The drawing shows a product supply path 1 via which the respective product 8 to be sliced is supplied by means of devices known per se of the cutting plane 2 of the slicer. A cutting blade 3 formed as a scythe-like blade or as a planetary revolving circular blade rotates around the cutting plane 2 and cooperates in this process with the cutting edge 4 provided at the end of the product supply path 1. On every revolution of the cutting blade, a slice is cut off the product 8 in accordance with the respectively effective feed; if no feed occurs, blank cuts are carried out.

The components of a transport system are located beneath the product supply path by means of which a paper web 6 can be supplied in the direction of the cutting plane 2 beneath the cutting edge 4 in a manner such that the cutting blade 3 cuts off a section of this paper web 6 together with a product slice on a revolution, said section then falling together with the cut-off slice as an intermediate layer onto a collection surface 9 for the sliced products.

The paper web 6 is drawn off from a dispensing roll 5 and led by means of suitable conveying devices to a perforating station 7 in which a transverse perforation is introduced into the paper web. Transverse perforations succeeding one another in the running direction of the web define the length of the respective paper section to be cut off as the intermediate layer since the paper feed is controlled or regulated such that the transverse perforation lies in the cutting plane 2 in every paper cutting step effected by the cutting blade 3.

It is, for example, possible due to the cutting through of the transverse perforation to reduce the actual paper cutting length to, for example, 30 to 40 mm in the event of a paper web with a width of 100 mm, with this reduced paper cutting length being made up of the sum of the width of the webs in the transverse perforation to be cut through.

It can thus be seen without problem that the blade service life can be substantially increased and can be more than doubled with respect to conventional apparatuses in which cutting has to take place without transverse perforation. Since the effort required to achieve this advantage is small, this advantage achieved by the invention has special significance.

1. An apparatus for the slicing of food products such as sausage, ham, cheese and the like comprising a device for the supply of the products (8) to be sliced to a cutting plane (2) defined by a rotating cutting blade (3) and by a cutting edge (4) cooperating therewith and provided at the end of the product supply path (1) as well as a transport system for a paper web (6) which is drawn off from a dispensing roll (5), is supplied to the cutting plane (2) and is fed in pre-determinable dependence on the cutting sequence such that the cutting blade (3), when cutting off a product slice, can also cut off a section from the paper web (6) which falls together with the cut-off slice as an intermediate layer onto a collection surface (9) for the sliced products, characterized in that
the transport system for the paper web (6) includes a station (7) for the transverse perforation of the paper web (6) and in that the paper feed is controlled or regulated such that the transverse perforation lies in the cutting plane (2) in each paper cutting step.

2. An apparatus in accordance with claim 1, characterized in that the station (7) for the transverse perforation has at least one perforating roll which is arranged adjacent to the cutting plane (2).

3. An apparatus in accordance with claim 1, characterized in that the transport system for the paper web (6) and the station (7) are arranged beneath the product supply path (1) for the transverse perforation.

4. An apparatus in accordance with claim 1, characterized in that the perforating roll is made such that the webs remaining in the transverse direction between the openings have a minimum width required for the further transport of the paper web (6).

5. An apparatus in accordance with claim 1, characterized in that the cutting blade (3) only cuts through the webs of the perforation remaining between the openings in each cutting of the paper web (6).

6. An apparatus in accordance with claim 1, characterized in that the blade (3) consists of a scythe-like blade.

7. An apparatus in accordance with claim 1, characterized in that the blade (3) consists of a planetarily revolving circular blade.

8. An apparatus for the slicing of food products such as sausage, ham, cheese and the like comprising a device for the supply of the products (8) to be sliced to a cutting plane (2) defined by a rotating cutting blade (3) and by a cutting edge (4) cooperating therewith and provided at the end of the product supply path (1) as well as a transport system for a paper web (6) which is drawn off from a dispensing roll (5), is supplied to the cutting plane (2) and is fed in pre-determinable dependence on the cutting sequence such that the cutting blade (3), when cutting off a product slice, also cuts off a section from the paper web (6) which falls together with the cut-off slice as an intermediate layer onto a collection surface (9) for the sliced products, characterized in that
the paper web (6) has transverse perforations spaced apart in the running direction and in that the paper feed is controlled or regulated such that the transverse perforation lies in the cutting plane (2) in each paper cutting step.
